(19) United States
(12) Patent Application Publication
(10) Pub. No.: US 2005/0076349 A1
(43) Pub. Date: Apr. 7, 2005

(54) Disk drive

(75) Inventors: Takeo Santo, Osaka (JP); Masahiro Inata, Itami-shi (JP); Kozo Ezawa, Osaka (JP); Gorou Naoki, Osaka (JP); Yoshito Saji, Ashiya-shi (JP)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: Matsushita Electric Industrial Co., Ltd.

(21) Appl. No.: 10/951,838

(22) Filed: Sep. 28, 2004

(30) Foreign Application Priority Data
Oct. 1, 2003 (JP) 2003-343700

(51) Int. Cl. G11B 17/03; G11B 17/04; G11B 33/02; G11B 7/24; G11B 23/03

(52) U.S. Cl. 720/616

(57) ABSTRACT

A disk drive, selectively accommodating a cartridge with a disk and at least one positioning hole on the bottom or the disk only, includes: a drive mechanism; a read/write head; a tray for putting the cartridge or the disk thereon, inserting it to a first position, in which the drive mechanism can mount the disk, and ejecting it to a second position, in which the cartridge or the disk is removable; and at least one positioning pin, which has a top portion inserted into the positioning hole to position the cartridge within a plane parallel to the disk. The tray has at least one clearance hole, into which the positioning pin is inserted such that the top portion thereof is fitted with the positioning hole of the cartridge in the first position, and the center of the clearance hole is offset to the center of axis of the top portion.

### BACKGROUND OF THE INVENTION

1. Field of the Invention

The present invention relates to a disk drive for reading and/or writing data from/on a disklike data storage medium housed in a cartridge.

2. Description of the Related Art

Recently, various types of portable and removable disklike data storage media (which will be simply referred to herein as “disks”), including optical disks and magnetic disks, have become very popular and adaptively used according to their intended applications. Examples of optical disks from/on which data is supposed to be read or written with a laser beam include read-only types such as CD-ROMs and DVD-ROMs, write-once types such as CD-Rs and DVD-Rs, and rewritable/recordable types such as PDs and DVD-RAMs. A rewritable disk is sometimes housed in a cartridge to protect the disk from scratches or dust.

To accommodate these types of disks, a disk drive needs to ensure a sufficient degree of compatibility. For that purpose, the base material thicknesses and track pitches of various types of DVDs are equalized with each other to comply with the DVD standards, thereby allowing the same optical head to process the read-only, write-once and rewritable disks easily.

A disk drive also needs to accommodate both a disk housed in a cartridge such as a rewritable type and a bare disk with no cartridge such as a read-only type. This means that an internal mechanism of the disk drive for inserting and ejecting a disk into/from the disk drive too has to accommodate both a cartridge and a bare disk alike.

In a disk drive, such a disk inserting/ejecting mechanism often uses a tray. This mechanism loads or unloads a disk into/from the disk drive by either putting the disk on the tray and inserting the tray, including the disk, into the disk drive or ejecting the tray with the disk from the disk drive. This tray-driven operation is easy to understand for most users and this mechanism is realized with a relatively simple structure. Thus, this mechanism is adopted in a lot of disk drives.

The disk inserting/ejecting mechanism also needs to accommodate both a cartridge and a bare disk alike as described above. To fill that need, a disk drive that can put both a bare disk and a cartridge on the same tray was proposed in Japanese Laid-Open Publication No. 2003-208749, for example. Also, to accept disks complying with different sets of standards, a disk drive accommodating different types of cartridges was proposed in Japanese Laid-Open Publication No. 2003-162860, for example.

Hereinafter, a conventional disk drive of the former type as disclosed in Japanese Laid-Open Publication No. 2003-208749 will be described with reference to FIGS. 10 and 11. FIG. 10 is a perspective view illustrating a conventional disk drive as disclosed in Japanese Laid-Open Publication No. 2003-208749. FIG. 11 is a perspective view illustrating a tray and a cartridge for use in the conventional disk drive shown in FIG. 10.

The disk drive 300 shown in FIG. 10 selectively accommodates the cartridge 202 shown in FIG. 11 or only the bare disk housed in the cartridge 202. As shown in FIG. 10, the disk drive 300 includes the tray 206, a drive chassis 210, a disk motor 212 and an optical head 213. The disk motor 212 is fixed on a traverse base (not shown). Also, the optical head 213 is supported on the traverse base so as to be movable in the radial direction of the disk. The traverse base is supported on the drive chassis 210 so as to step back when the tray 206 is inserted.

As shown in FIG. 11, the cartridge 202 includes a shutter 204 for opening or closing a window that exposes the data storage side of the disk when opened and two positioning holes 205s and 205t that determine the position of the cartridge 202 in the disk drive. As shown by broken lines in FIG. 11, the positioning holes 205s and 205t are provided on the lower surface of the cartridge 202. The cartridge 202 houses a disk 201 therein.

The tray 206 includes a mount 206a and a pair of guide walls 206l and 206r. The guide walls 206l and 206r are spaced apart from each other by a gap that is slightly wider than the width of the cartridge 202 so as to sandwich the mount 206a between them and to guide the cartridge 202 to its mount position on the tray 206. The mount 206a has a head access window 26h and two concentric recesses 206b of different diameters. If only the disk 201 should be loaded into the disk drive 300 by itself, then the disk 201 is put as a bare disk on the bigger recess 206b. In inserting a bare disk of a smaller diameter, the disk is put on the smaller recess 206b. The mount 206a further includes a pair of clearance holes 206s.

In loading the cartridge 202 into the disk drive 300, first, the cartridge 202 is put on the mount 206a of the ejected tray 206 using the guide walls 206l and 206r. Next, when an eject switch (not shown) is pressed down, a driver (not shown) inserts the tray 206 into the disk drive 300. Then, the tab 208a of an opener 208, which is supported in a deep region of the tray 206 so as to slide horizontally, gets engaged with the protrusion 204a of the shutter 204 of the cartridge 202 inserted. A pin 208b sticking out of the opener 208 interlocks with a guide groove provided on a top portion plate (not shown). Accordingly, as the tray 206 is inserted, the opener 208 moves horizontally along the guide groove, thereby opening the shutter 204.

When the tray 202 is inserted completely, the traverse base, which has been located under the tray 202, is rotated and lifted by a traverse lifting/driving mechanism (not shown). As a result, the disk motor 212 mounts the disk 201 in the cartridge 202 on its turntable and holds it in a rotatable position. In the meantime, the optical head 213 has moved to a predetermined position so as to face the data storage side of the disk 201 that is exposed through the disk window of the cartridge 202.

As the traverse base is being rotated and lifted, a pair of positioning pins 217, which is supported in a rotatable position by the disk drive 300, is also rotated and lifted by the traverse lifting/driving mechanism, passed through the clearance holes 206s of the tray 206 and then fitted with the positioning holes 205s and 205t of the cartridge 202. By getting these positioning pins 217 engaged, the cartridge 202 is fixed at its predetermined position with respect to the disk drive 300.

In loading the disk 201 by itself into the disk drive 300, first, the disk 201 is put on the bigger recess 206b in the mount 206a of the tray 206 ejected. Thereafter, the same operations as those described above are performed to mount the disk 201 on the disk motor 212. As in loading the cartridge 202, the positioning pins 217 are also lifted almost as the traverse base is being rotated and lifted. In this case, however, there is no cartridge 202 to receive the positioning pins 217. Accordingly, when the disk 201 is inserted alone, the positioning pins 217 have no particular function to perform.

In the conventional disk drive accommodating both a cartridge and a bare disk, its tray needs to have recesses to put the bare disk thereon and clearance holes to receive the positioning pins. However, the clearance holes are adjacent to the recesses to put the bare disk. Accordingly, the thickness of the tray must be reduced around the clearance holes, thus decreasing the mechanical strength of the tray unintentionally. In addition, when the tray is formed by an injection molding process, the resin cannot reach the contact portions between the clearance holes and the recesses easily, thus warping the resultant tray easily.

Furthermore, the clearance holes, formed by removing portions of the recesses, affect the appearance of the tray and restrict the freedom of design.

### SUMMARY OF THE INVENTION

In order to overcome the problems described above, preferred embodiments of the present invention provide a disk drive that can accommodate various types of media flexibly using a tray with increased mechanical strength, moldability and freedom of design.

A disk drive according to a preferred embodiment of the present invention preferably selectively accommodates a cartridge, in which a disk with a data storage side is housed and which has at least one positioning hole on its bottom, or the disk by itself. The disk drive preferably includes: a drive mechanism for mounting, rotating and driving the disk thereon; a head for reading and/or writing data from/on the data storage side of the disk; a tray for putting either the cartridge or the disk thereon, the tray inserting the cartridge or the disk to a first position, in which the drive mechanism is able to mount the disk thereon, and ejecting the cartridge or the disk from the first position to a second position, in which the cartridge or the disk is removable from the disk drive; and at least one positioning pin, which has a top portion to be inserted into the positioning hole of the cartridge to position the cartridge within a plane that is defined parallel to the disk. The tray preferably has at least one clearance hole, into which the positioning pin is inserted such that the top portion of the positioning pin is inserted into, and fitted with, the positioning hole of the cartridge in the first position. And the center of the clearance hole is preferably offset with respect to the center of axis of the top portion of the positioning pin.

In one preferred embodiment of the present invention, the center of the clearance hole is preferably located more distant from the center of rotation of the drive mechanism than the center of axis of the top portion is in at least one of two directions that are parallel to, and perpendicular to, a direction in which the tray is inserted.

In this particular preferred embodiment, the magnitude of the offset is preferably at least equal to 0.5 mm.

In another preferred embodiment, the positioning pin preferably further includes a base portion, which is provided around the top portion and which contacts with a portion of the cartridge surrounding the positioning hole, thereby positioning the cartridge perpendicularly to the disk.

In that case, the center of axis of the base portion is preferably offset with respect to that of the top portion.

In a specific preferred embodiment, the center of axis of the base portion is preferably offset so as to be located more distant from the center of rotation of the drive mechanism than the center of axis of the top portion is.

More specifically, the center of the clearance hole of the tray preferably matches the center of axis of the base portion.

In still another preferred embodiment, the tray preferably has a recess to put the disk thereon.

In that case, the gap between the outer peripheries of the recess and the clearance hole is at least 1 mm.

In yet another preferred embodiment, the clearance hole preferably has a circular cross section.

A disk drive according to another preferred embodiment of the present invention preferably selectively accommodates one of cartridges of first and second types, in each of which a disk with a data storage side is housed and each of which has at least one positioning hole on its bottom, or only the disk that has been housed in at least one of the cartridges of the first and second types. The positioning hole of the first type of cartridge is preferably located at a different position from that of the second type of cartridge. The disk drive preferably includes: a drive mechanism for mounting, rotating and driving the disk thereon; a head for reading and/or writing data from/on the data storage side of the disk; a tray for putting the cartridge of the first or second type thereon, the tray inserting the first or second type of cartridge to a first position, in which the drive mechanism is able to mount the disk thereon, and ejecting the first or second type of cartridge from the first position to a second position, in which the first or second type of cartridge is removable from the disk drive; and at least first and second positioning pins, each of which has a top portion to be inserted into the positioning hole of its associated cartridge of the first or second type to position the cartridge within a plane that is defined parallel to the disk. The tray preferably has at least one clearance hole, into which the first or second positioning pin is inserted such that the top portion of the first or second positioning pin is inserted into the positioning hole of the first or second type of cartridge in the first position.

In one preferred embodiment of the present invention, each of the first and second positioning pins preferably further includes a base portion, which is provided around the top portion and which contacts with a portion of the first or second type of cartridge surrounding the positioning hole, thereby positioning the cartridge perpendicularly to the disk. In at least one of the first and second positioning pins, the center of axis of the base portion is preferably offset with respect to that of the top portion.

In this particular preferred embodiment, the distance between the centers of axes of the base portions of the first and second positioning pins is preferably shorter than the distance between the centers of axes of the top portions of the first and second positioning pins.

In a specific preferred embodiment, the clearance hole of the tray is preferably elongated in a direction in which the tray is inserted.

In yet another preferred embodiment, in each of the first and second positioning pins, the center of axis of the base portion is preferably offset with respect to that of the top portion, and the directions of offset in the first and second positioning pins are preferably different from each other.

A cartridge positioning structure according to a preferred embodiment of the present invention is preferably used in a disk drive that selectively accommodates a cartridge, in which a disk with a data storage side is housed and which has at least one positioning hole on its bottom, or the disk by itself. The positioning structure preferably includes: a tray for putting either the cartridge or the disk thereon, the tray inserting the cartridge or the disk to a first position, in which a drive mechanism is able to mount the disk thereon, and ejecting the cartridge or the disk from the first position to a second position, in which the cartridge or the disk is removable from the disk drive; and at least one positioning pin, which includes a top portion to be inserted into the positioning hole of the cartridge to position the cartridge within a plane that is defined parallel to the disk and a base portion, which is provided around the top portion and which contacts with a portion of the cartridge surrounding the positioning hole, thereby positioning the cartridge perpendicularly to the disk. The tray preferably has at least one clearance hole, into which the positioning pin is inserted such that the top portion of the positioning pin is inserted into, and fitted with, the positioning hole of the cartridge in the first position. The base portion of the positioning pin preferably expands 0.5 mm or less toward the center of rotation of the drive mechanism.

In one preferred embodiment of the present invention, the tray preferably has a recess to put the disk thereon.

In this particular preferred embodiment, the gap between the outer peripheries of the recess and the clearance hole is preferably at least 1 mm.

In another preferred embodiment, the clearance hole preferably has a circular cross section.

In that case, the center of axis of the base portion is preferably offset with respect to that of the top portion.

In a specific preferred embodiment, the center of the clearance hole is preferably offset so as to be more distant from the center of rotation of the drive mechanism than the center of axis of the top portion is.

More particularly, the magnitude of offset is preferably at least equal to 0.5 mm.

Various preferred embodiments of the present invention described above are effectively applicable for use in a disk drive, which can accommodate a cartridge and a bare disk, and in a cartridge positioning structure for such a disk drive. In addition, the preferred embodiments of the present invention are also applicable for use in a disk drive, which can accommodate a bare disk and multiple cartridges of mutually different types, and in a cartridge positioning structure for such a disk drive.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIGS. 1A and 1B are respectively a plan view and a cross-sectional view of a cartridge to be loaded into a disk drive according to a first specific preferred embodiment of the present invention.

FIG. 2 is an exploded perspective view illustrating the structure of a disk drive according to the first preferred embodiment.

FIG. 3 is a perspective view illustrating the tray structure of the disk drive shown in FIG. 2.

FIG. 4 is a plan view illustrating a state where the cartridge has been put on the tray in the first preferred embodiment of the present invention.

FIG. 5A is a cross-sectional view schematically illustrating the thicknesses of the clearance hole and bare disk recess of the tray in the first preferred embodiment.

FIGS. 5B and 5C are cross-sectional views schematically illustrating the thicknesses of the clearance hole and bare disk recess in conventional disk drives.

FIG. 6 is a plan view showing exemplary dimensions of the tray clearance hole and positioning pin in a situation where the cartridge is a DVD-RAM in the first preferred embodiment.

FIGS. 7A and 7B are respectively a plan view and a cross-sectional view of a second type of cartridge to be loaded into a disk drive according to a second specific preferred embodiment of the present invention.

FIG. 8 is an exploded perspective view illustrating the structure of a disk drive according to the second preferred embodiment.

FIG. 9 is a plan view illustrating a state where the second type of cartridge has been put on the tray in the second preferred embodiment of the present invention.

FIG. 10 is a perspective view illustrating the structure of a conventional disk drive.

FIG. 11 is a perspective view illustrating the tray and cartridge of the conventional disk drive shown in FIG. 10.

### DETAILED DESCRIPTION OF PREFERRED EMBODIMENTS

Hereinafter, preferred embodiments of the present invention will be described with reference to the accompanying drawings.

Embodiment 1

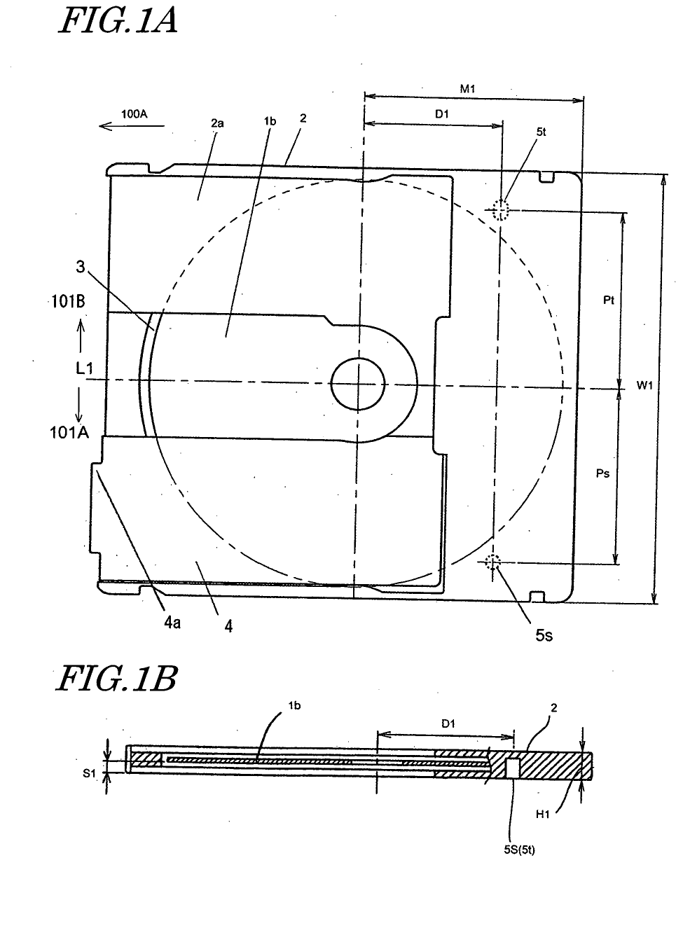

First, a cartridge 2 to be loaded into a disk drive according to a first specific preferred embodiment of the present invention will be described with reference to FIGS. 1A and 1B, which are a plan view showing the upside of the cartridge 2 and a cross-sectional view of the cartridge 2, respectively. The cartridge 2 may be a DVD-RAM cartridge, for example.

The cartridge 2 includes a body 2a to house a disk 1b therein and a shutter 4. A disk window 3 is opened through the two principal surfaces of the body 2a so as to partially expose the data storage side and the opposite side of the disk 1b, respectively. The shutter 4 has a U-cross section with a rectangular bottom and wraps the body 2a around so as to slide in one of the two directions pointed by the arrows 111A and 110B in FIG. 1A. Normally, the shutter 4 covers the disk window 3 provided through the two principal surfaces of the body 2a. The body 2a has positioning holes 5s and 5t to fix the cartridge 2 at a predetermined position within the disk drive. Specifically, the positioning hole 5s has a circular cross section and defines the position of the cartridge 2. The other positioning hole 5t is elongated toward the positioning hole 5s and regulates the rotation of the cartridge 2.

When the cartridge 2 is positioned within the disk drive with the disk 1b mounted on the turntable, the distance between the centerline L1 of the disk 1b, which crosses the line that connects together the respective centers of the positioning holes 5s and 5t at right angles, and the center of the positioning hole 5s is identified by Ps. On the other hand, the distance between the centerline L1 and the center of the positioning hole 5t is identified by Pt. In a DVD-RAM cartridge, for example, Ps and Pt are equal to each other. The distance from the center of the disk 1b to the line that connects together the respective centers of the positioning holes 5s and 5t is identified by D1. Also, the distance from the center of the disk 1b to the side surface of the cartridge 2 opposed to the disk window 3 is identified by M1. The cartridge 2 is supposed to have a width W1. As will be described later, the cartridge 2 is inserted into the disk drive in the direction pointed by the arrow 100A in FIG. 1A. The direction pointed by the arrow 100A is referred to as an insertion direction.

As shown in FIG. 1B, the cartridge 2 is supposed to have a thickness H1. Also, in a situation where the disk 1b is mounted on the turntable so as to rotate within the cartridge body 2a, the distance from the bottom of the cartridge 2 to the data storage side of the disk 1b is identified by S1.

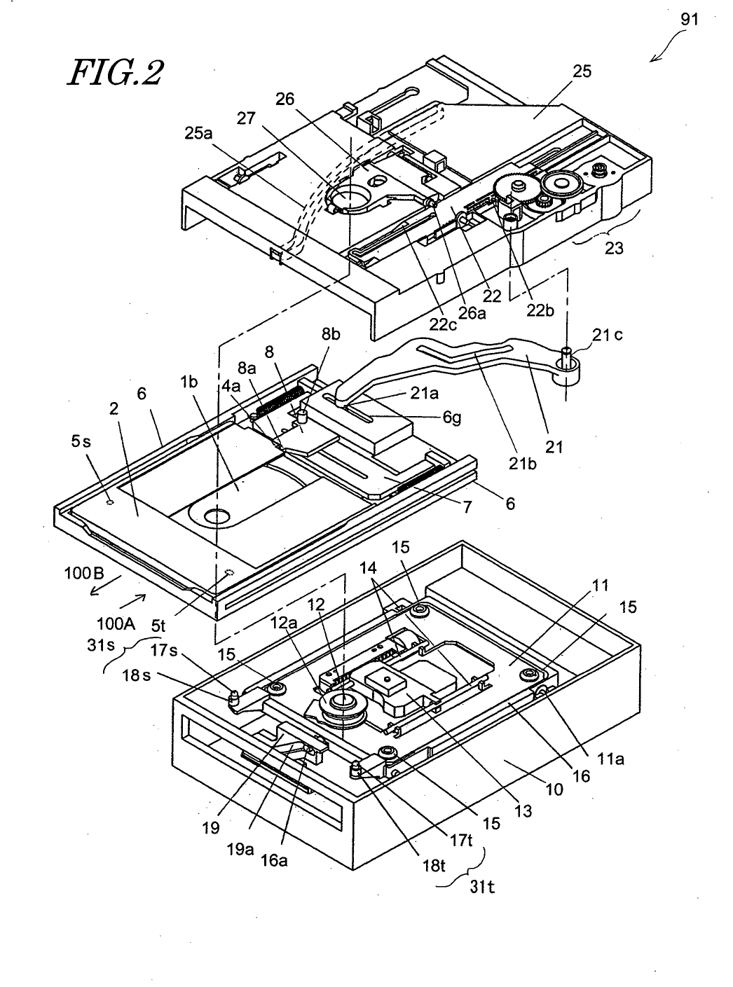

Hereinafter, a disk drive 91 according to the first preferred embodiment will be described with reference to FIG. 2, which is an exploded perspective view of the disk drive 91. As shown in FIG. 2, the disk drive 91 includes a tray 6, a disk motor 12, an optical head 13, and positioning pins 31s and 31t. Also, the housing of the disk drive 91 includes a mechanical chassis 10 and a top portion plate 25.

As will be described in detail later, the tray 6 has a structure to mount both the cartridge 2 shown in FIGS. 1A and 1B and the bare disk 1b alike at respective predetermined positions. Also, the tray 6 has an opener 8 for opening and closing the shutter of the cartridge 2. The tray 6 is supported by the top portion plate 25 so as to be movable in the direction pointed by one of the arrows 100A and 100B.

An arm 21, a tray driving rack 22, a tray drive mechanism 23, a damper holder 26 and an opener guide groove 25a are provided for the top portion plate 25. The arm 21 has a pin 21a and a shaft 21b at both ends thereof and is supported by the top portion plate 25 so as to rotate on the shaft 21b. The pin 21a interlocks with a groove 6g provided for the tray 6. The tray driving rack 22 includes a rack portion 22b, which receives driving force from the tray drive mechanism 23 by way of a decelerating gear. The tray 6 is driven by the tray driving rack 22 in the directions pointed by the arrows 100A and 100B.

The damper holder 26 includes a damper 27 and a supporting pin 26a. The damper 27 is supported in a rotatable position by the damper holder 26. Also, a spring or any other elastic member (not shown) applies elastic force to the damper 27 such that the damper 27 is pressed toward the disk 1b. The supporting pin 26a of the clamper holder 26 engages with the tray driving rack 22. Thus, as the tray driving rack 22 moves, the damper 27 also moves upward or downward.

The disk motor 12 has a turntable 12a to mount and rotate the disk 1b thereon and is supported on a traverse base 11. The optical head 13 reads or writes data from/on the data storage layer of the disk 1b. Also, to move in the radial direction of the disk 1b mounted on the turntable 12a, the optical head 13 is supported on the traverse base 11 by a pair of shafts 14 that are arranged substantially parallel to each other.

The traverse base 11 is supported by a traverse holder 16 by way of dampers 15. Also, the traverse base 11 is further supported by the mechanical chassis 10 so as to be rotatable around the fulcrum of rotation 11a defined near one end of the traverse base 11. The positioning pins 31s and 31t are fixed near the other end of the traverse base 11 opposite to the fulcrum of rotation 11a.

The positioning pins 31s and 31t respectively have top portions 17s and 17t, which are inserted into the positioning holes 5s and 5t of the cartridge 2, respectively, thereby positioning the cartridge 2 within a plane that is defined parallel to the disk 1b. In addition, the positioning pins 31s and 31t preferably further include base portions 18s and 18t, which contact with the cartridge 2 around the positioning holes 5s and 5t, respectively, thereby positioning the cartridge 2 perpendicularly to the disk 1b. The the positioning pins 31s and 31t and the tray 6 function cooperatively as a cartridge positioning structure to position the cartridge 2.

To lift the traverse base 11 by rotating it around the fulcrum of rotation 11a, the mechanical chassis 10 is provided with a lifting cam 19. The lifting cam 19 has a cam groove 19a, which interlocks with a lifting pin 16a that is provided near the other end of the traverse base 11 opposite to the fulcrum of rotation 11a thereof. The lifting cam 19 is driven by a drive mechanism (not shown) perpendicularly to the directions pointed by the arrows 100A and 100B. As a result, the lifting pin 16a, interlocking with the cam groove 19a, is also raised, thereby rotating the traverse base 11 around the fulcrum of rotation 11a and lifting the traverse base 11.

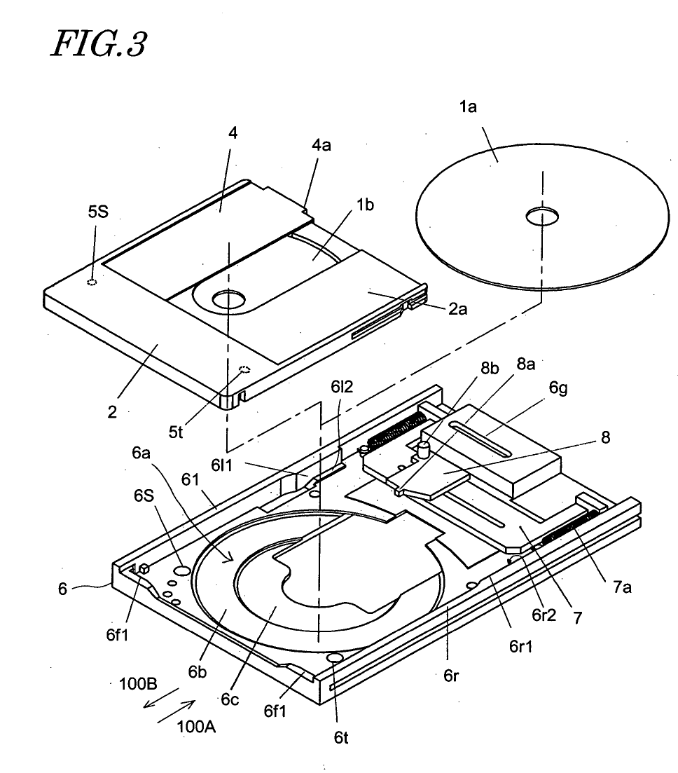

Hereinafter, the detailed structure of the tray 6 will be described with reference to FIG. 3, which is a perspective view illustrating the tray 6, cartridge 2 and disk 1b.

The tray 6 has a cartridge mount 6a to put the cartridge 2 thereon. A circular recess 6b to put the bare disk 1b of the cartridge 2 thereon is provided as the center portion of the cartridge mount 6a. To put a smaller bare disk than the disk 1b by itself, another circular recess 6c, which is concentric with the recess 6b and has a smaller radius than the recess 6b, may be further provided. The diameters of these recesses 6b and 6c are appropriately determined by the sizes of the bare disks. For example, if the disk 1b is a CD or a DVD, the disk 1b has a diameter of 12 cm. Accordingly, the diameter of the recess 6b is defined slightly greater than 12 cm. On the other hand, the diameter of the other recess 6c may be set approximately equal to, or slightly greater than, 8 cm.

A right wall 6r, a left wall 6l and a front wall 6f1 are provided on the right- and left-hand sides of the tray 6 and on the front end (i.e., the end closest to the user) of the tray 6, respectively. The right and left walls 6r and 6l are used as guides to put the cartridge 2 on this tray 6. The gap between the narrowest portions 6r1 and 6l1 of the right and left walls 6r and 6l at a deep portion the tray 6 is set slightly broader than the width W1 of the cartridge 2. On the cartridge mount 6a, receiving portions 6r2 and 6l2 are provided adjacent to the narrowest portions 6r1 and 6l1, respectively, so as to contact with the cartridge body 2a and support the cartridge 2 thereon when the cartridge 2 is put on the tray 6.

The tray 6 further includes a springing portion 7, to which elastic force is applied from springs 7a toward the front end of the tray 6. Thus, when the cartridge 2 is put on the cartridge mount 6a, the cartridge 2 is pressed against the front wall 6f1 and fixed provisionally within the tray 6.

The opener 8 is supported by the springing portion 7 so as to slide perpendicularly to the directions pointed by the arrows 100A and 100B. The opener 8 includes a tab 8a to engage with a stepped portion 4a provided for the shutter 4 of the cartridge 2 and a pin 8b to interlock with the opener guide groove 25a of the top portion plate 25.

Once the cartridge 2 carried by the tray 6 has been inserted fully into the disk drive, the disk 1b in the cartridge 2 is soon mounted on the turntable 12a of the disk motor 12. That fully inserted position of the cartridge 2 will be referred to herein as a “first position”. The cartridge mount 6a of the tray 6 has clearance holes 6s and 6t to receive the positioning pins 31s and 31t such that the positioning pins 31s and 31t fit with the positioning holes 5s and 5t of the cartridge 2, respectively, when the cartridge 2 on the tray 6 is located at the first position.

Hereinafter, it will be described with reference to FIGS. 2 and 3 how the disk drive 91 operates. The operation of loading the cartridge 2 is started when the operator presses down an eject switch (not shown), for example. In response, first, the tray drive mechanism 23 drives the tray driving rack 22 in the direction 100B by way of a decelerating gear. At this point in time, the traverse base 11 has already been rotated and brought down under the tray 6 so as to avoid contacting with the tray 6 being ejected. The tray driving arm 21 rotates and moves in the direction 100B around the pin 22a provided for the tray driving rack 22. As a result, the tray 6 is moved in the direction 100B and ejected by the top portion pin 21a out of the disk drive. At this position, either the cartridge 2 or the bare disk 1b is put on the tray 6 by the users. Such position will be referred to herein as a “second position”.

Thereafter, the operator presses down the eject switch again. Then, the tray drive mechanism 23 drives the tray driving rack 22 in the direction 100A by way of the decelerating gear. The tray driving arm 21 rotates and moves in the direction 100A around the pin 22a of the tray driving rack 22. As a result, the tray 6 is inserted by the top portion pin 21a into the disk drive. At this point in time, the traverse base 11 has already been rotated and brought down under the tray 6 so as to avoid contacting with the tray 6 or cartridge 2 being inserted.

As the tray 6 is inserted, the pin 8b of the opener 8 is guided by the opener guide groove 25a of the top portion plate 25, thereby shifting the opener 8 perpendicularly to the inserting direction. Also, the tab 8a of the opener 8 engages with the stepped portion 4a of the shutter 4 of the cartridge 2. Accordingly, the shutter 4 is opened as the tray 6 is inserted.

Furthermore, while the tray 6 is being inserted, the damper 27 is still elevated at a high position so as to avoid contacting with the cartridge 2 being inserted. However, once the tray 6 has been inserted, the supporting pin 26a goes down along the tapered portion 22c of the tray driving rack 22. As a result, the damper 27 is brought down toward the disk 1b that has been exposed as a result of the shutter's opening.

Also, once the tray 6 has been inserted fully, the lifting cam 19 is driven by a lifting driving mechanism (not shown), thereby moving the lifting pin 16a, interlocking with the cam groove 19a, upward along the cam groove 19a. As a result, the traverse base 11, along with the traverse holder 16, is rotated and lifted. In the meantime, the disk motor 12 accesses the disk 1b through the disk window of the cartridge 2 and mounts the disk 1b on the turntable 12a. On the other hand, the damper 27 is ready to hold the disk 1b above the disk motor 12. And by utilizing magnetic attraction between a magnet (not shown) embedded in either the damper 27 or the disk motor 12 and a magnetic plate (not shown, either), the disk 1b is sandwiched between the disk motor 12 and the damper 27 and fixed in a rotatable position. At the same time, the optical head 13 is moved to its predetermined position so as to face the data storage side of the disk 1b, which is exposed through the disk window of the cartridge 2.

As the traverse base 11 is rotated and lifted, the positioning pins 31s and 31t are also raised to get fitted with the positioning holes of the cartridge 2 by way of the clearance holes 6s and 6t of the tray 6. When the positioning pins 31s and 31t are fixed in this manner, the disk 1b in the cartridge 2 is also fixed two-dimensionally.

Also, the base portions 18s and 18t receive the bottom of the cartridge 2 around the positioning holes 6s and 6t, thereby determining the position of the cartridge 2 perpendicularly to the disk 1b. In this case, the distance between the bottom of the cartridge 2 and the data storage side of the disk 1b is equal to S1 such that data is ready to be read from or written on the disk 1b.

As a result of this series of operations, the cartridge 2 is loaded into the disk drive to get the disk 1b ready to read data from or write data on. In unloading the cartridge 2, the respective members just operate in the opposite way to that described above. Thus, the detailed description thereof will be omitted herein.

In inserting the disk 1b by itself into the disk drive 91, first, the disk 1b is put on the outer recess 6b of the tray 6. When a smaller disk is inserted, the disk is put on the inner recess 6c of the tray 6. In any case, in inserting a bare disk by itself into the disk drive 91, the opener 8 and positioning pins 31s and 31t operate just as described above except that there is no cartridge to receive the positioning pins 31s and 31t.

The disk 1b is mounted on the disk motor 12 and firmly held by the damper 27 just as described above, too.

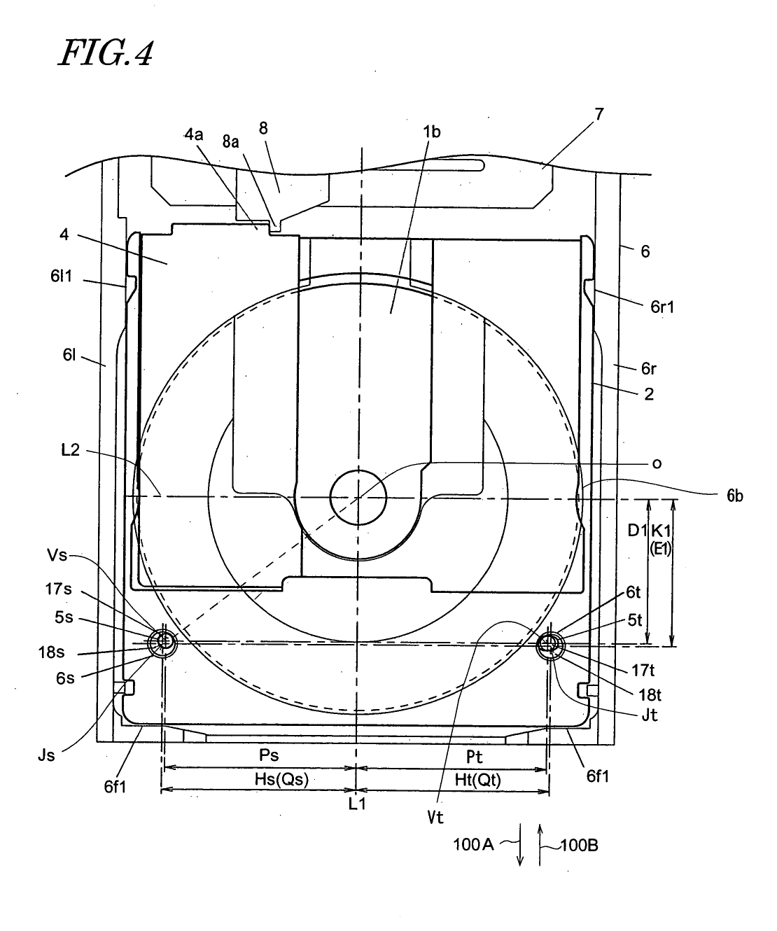

Next, the structures of the clearance holes 6s and 6t of the tray 6 and the positioning pins 31s and 31t will be described in detail. FIG. 4 is a plan view illustrating a state where the cartridge 2 has been put on the tray 6 (i.e., the cartridge 2 is now located in the first position). The respective top portions 17s and 17t of the positioning pins 31s and 31t are inserted into the positioning holes 5s and 5t of the cartridge 2. In the first position, the center O of the disk 1b is aligned with the axis of rotation of the disk motor 12. As shown in FIG. 4, the distance from the centerline L1, passing the center O and extending parallel to the direction in which the tray 6 moves (i.e., the directions pointed by the arrows 100A and 100B), to the center Js of the clearance hole 6s is identified by Hs, while the distance from the centerline L1 to the center Jt of the other clearance hole 6t is identified by Ht. Hs and Ht are equal to each other. On the other hand, the distance from the centerline L2, also passing the center O but extending perpendicular to the direction in which the tray 6 moves (i.e., the directions pointed by the arrows 100A and 100B), to the center Js of the clearance hole 6s and to the center Jt of the clearance hole 6t is identified by K1.

On the other hand, the distance from the centerline L1 to the center of the axis Vs of the top portion 17s of the positioning pin 31s is identified by Ps, while the distance from the centerline L1 to the center of the axis Vt of the top portion 17t of the positioning pin 31t is identified by Pt. Ps and Pt are equal to each other. On the other hand, the distance from the centerline L2 to the center of the axis Vs of the top portion 17s of the positioning pin 31s and to the center of the axis Vt of the top portion 17t of the positioning pin 31t is identified by D1.

The positioning pins 31s and 31t include base portions 18s and 18t, respectively, of which the centers of axes Vs and Vt match the centers Js and Jt of the clearance holes 6s and 6t, respectively. Accordingly, the distances from the centerline L1 to the centers of axes Vs and Vt of the base portions 18s and 18t are Qs and Qt, which are equal to Hs and Ht, respectively. Also, the distance from the centerline L2 to the centers of axes Vs and Vt of the base portions 18s and 18t is E1, which is equal to K1.

As shown in FIG. 4, the top portions 17s and 17t of the positioning pins 31s and 31t are inserted into the positioning holes 5s and 5t of the cartridge 2, and the base portions 18s and 18t thereof need to contact with portions of the cartridge 2 surrounding the positioning holes 5s and 5t, respectively. For that reason, the diameter of the base portions 18s and 18t is greater than that of the top portions 17s and 17t. Also, the clearance holes 6s and 6t need to be big enough to pass the base portions 18s and 18t, respectively. Furthermore, since the locations of the positioning holes 5s and 5t of the cartridge 2 are defined by the standards, the centers of the axes of the top portions 17s and 17t cannot be shifted. To satisfy these relationships, the diameter of the clearance holes 6s and 6t needs to be greater than that of the top portions 17s and 17t and the centers of axes of the top portions 17s and 17t must be fixed. Even so, the clearance holes 6s and 6t themselves can be shifted away from the recess 6b. In this case, the base portions 18s and 18t can also be shifted along with the clearance holes 6s and 6t.

As shown in FIG. 4, these distances satisfy the relationships D1<K1=E1, Pt<Ht (=Qt) and Ps<Hs (=Qs). That is to say, while the cartridge 2 is located in the first position, the centers Js and Jt of the clearance holes 6s and 6t are not aligned with, but are offset from, the centers of axes Vs and Vt of the top portions 17s and 17t of the positioning pins 31s and 31t. The clearance holes 6s and 6t are preferably offset so as to be more distant from either the centerline L1, which is parallel to the direction in which the tray 6 moves (i.e., so as to satisfy Pt<Ht and Ps<Hs), or the centerline L2, which is perpendicular to the tray moving direction (i.e., so as to satisfy D1<K1). More preferably, the centers Js and Jt of the clearance holes 6s and 6t are offset so as to be more distant from the center O of the disk 1b than the centers of axes Vs and Vt of the top portions 17s and 17t of the positioning pins 31s and 31t are. That is to say, it is more preferable that the distance between the centers Js and O is greater than the distance between the centers Vs and O and that the distance between the centers Jt and O is greater than the distance between the centers Vt and O. Thus, as will be described in further detail later, these clearance holes 6s and 6t never become too close to, or adjacent to, the recess 6b for mounting the disk 1b thereon, to avoid decreasing the thickness or the mechanical strength of the tray 6 excessively around them.

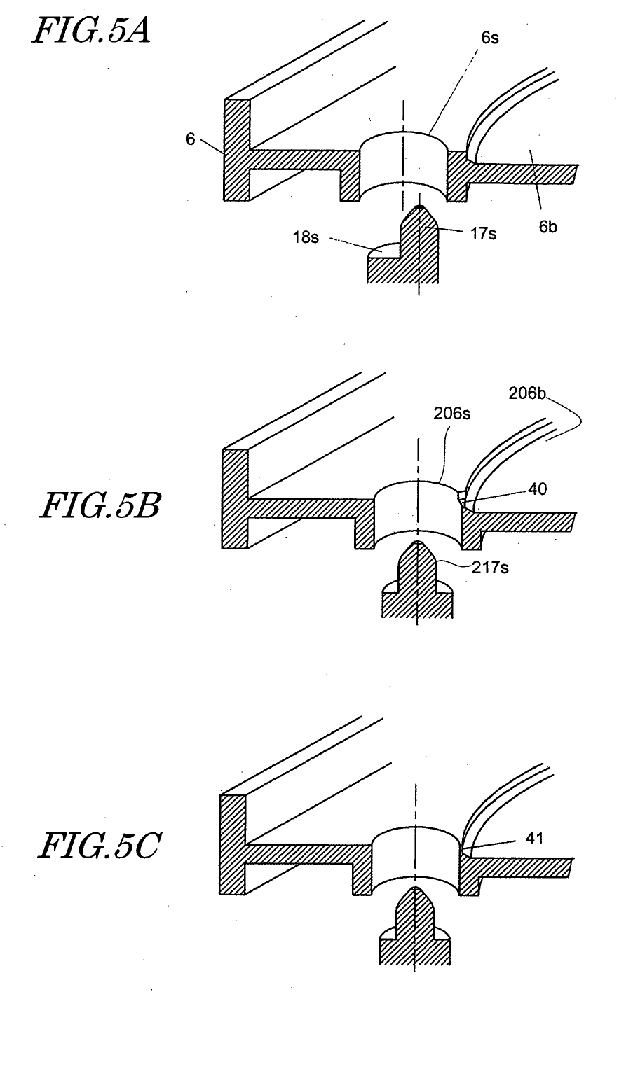

FIG. 5A is a cross-sectional view schematically illustrating the thicknesses of the clearance hole 6s and the recess 6b of the tray 6.

As shown in FIG. 5A, the center of the clearance hole 6s is shifted from the center of axis of the top portion 17s of the positioning pin 31s and is brought more distant from the outer periphery of the recess 6b. Thus, the gap between the outer peripheries of the clearance hole 6s and recess 6b can be widened. As a result, this portion can be thickened and the mechanical strength of the tray 6 can be increased.

FIGS. 5B and 5C are cross-sectional views illustrating the trays of conventional disk drives. In the conventional disk drive shown in FIG. 5B, the center of its clearance hole 206s is aligned with the center of axis of the top portion 217s of its positioning pin, and therefore, the gap between the clearance hole 206s and the recess 206b becomes very narrow. Accordingly, to prevent resin from flowing irregularly during the resin molding process, a stepped portion 40 is provided. However, such a stepped portion 40 cannot be formed without partially removing outer portions of the clearance hole and recess, thus affecting the appearance of the tray.

Nevertheless, if no stepped portions are provided as in the conventional disk drive shown in FIG. 5C, then an excessively thin portion 41 is formed, thus making the resin flow irregular there while the tray is being molded of the resin and warping the resultant tray easily, for example. In contrast, according to this preferred embodiment, these problems can be avoided so that the tray can be formed with high precision and without its appearance affected. In addition, the centers of the clearance holes 6s and 6t do not have to match those of the top portions 17s and 17t of the positioning pins 31s and 31t. Accordingly, the tray can be designed much more freely so as to make a stronger impact on the users as a “feature” of the product so to speak.

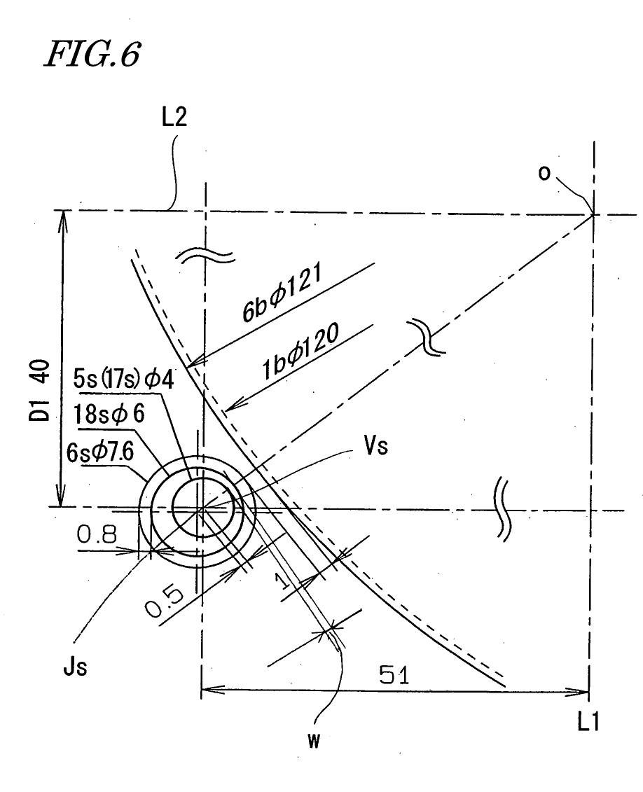

FIG. 6 shows a specific exemplary tray for a disk drive that accommodates a DVD-RAM cartridge. In FIG. 6, the recess 6b has a diameter of 121 mm, which is set 1 mm greater than the diameter of 120 mm of the disk 1b. The positioning hole 5s and the top portion 17s of the positioning pin 31s have approximately the same diameter of 4 mm. The base portion 18s of the positioning pin 31s has a diameter of 6 mm so as to receive the bottom of the cartridge 2 in a sufficiently wide area. To prevent the clearance hole 6s from contacting with the base portion 18s in an unexpectedly manner and interfering with the upward or downward movement of the positioning pin 31s and the positioning of the cartridge 2, the clearance hole 6s is preferably somewhat bigger than the base portion 18s. In this example, the radius of the clearance hole 6s is set 0.8 mm greater than that of the base portion 18 and the clearance hole 6s has a diameter of 7.6 mm. And the center Js of the clearance hole 6s matches the center of axis of the base portion 18s.

In a DVD-RAM cartridge, the standard defines the distance from the center of axis Vs of the top portion 17s of the positioning pin 31s (i.e., the center of the positioning hole 5s) to the centerline L1 to be 51 mm and the distance from the center of axis Vs to the centerline L2 to be 40 mm. By shifting the center of axis of the base portion 18s with respect to the center of axis Vs of this top portion 17s, the clearance hole 6s is shifted and the gap between the outer peripheries of the clearance hole 6s and recess 6b is widened.

As shown in FIG. 6, the center Js of the clearance hole 6s is offset so as to be 0.5 mm more distant from the center O of the disk 1b than the center of axis Vs of the top portion 17s is. In this case, a gap of at least 1 mm can be provided between the clearance hole 6s and the recess 6b. As a result, the portions of the tray 6 surrounding the clearance hole 6s can have increased mechanical strength and can be molded just as intended.

As is clear from FIG. 6, the magnitude of shift of the clearance hole 6s from the outer periphery of the recess 6b depends on the width W of a portion of the cartridge receiving plane of the base portion 18s expanding toward the center O of the disk 1b. In a disk drive accommodating a DVD-RAM cartridge, this expansion width W is preferably at least equal to 0.5 mm. Then, a gap of at least 1 mm can be provided between the clearance hole 6s and the recess 6b. As a result, the portions of the tray 6 surrounding the clearance hole 6s can have increased mechanical strength and can be molded just as intended.

In the preferred embodiment described above, the cartridge 2 is positioned by using the positioning holes 5s and 5t and the positioning pins 31s and 31t. Alternatively, the rotation of the cartridge 2 may also be regulated by the using the walls of the tray 6. In that case, there is no need to use the positioning hole 5t or provide the positioning pin 31t and clearance hole 6t. That is to say, the disk drive needs at least one positioning pin and at least one clearance hole then.

Also, in the preferred embodiment described above, the centers of the base portions 18s and 18t are matched with those of the clearance holes 6s and 6t of the tray 6. However, these two pairs of centers do not have to match each other. As long as the clearance holes 6s and 6t never interfere with the upward movement of the base portions 18s and 18t, the centers of the clearance holes 6s and 6t may be offset so as to be more distant from the center of the disk than the centers of axes of the base portions 18s and 18t are, for example.

Furthermore, the clearance holes 6s and 6t do not have to have a circular cross section but may have an elongated circular, elliptical, rectangular or polygonal cross section. Likewise, the cross-sectional shape of the base portions 18s and 18t does not have to be circular, either, as long as the base portions 18s and 18t can be inserted into the clearance holes 6s and 6t.

Embodiment 2

A second specific preferred embodiment of the present invention is a disk drive that can accommodate multiple types of cartridges. First, those cartridges to be loaded into the disk drive of this preferred embodiment will be described. The disk drive of this preferred embodiment can be loaded with at least first and second types of cartridges and can read and write data from/on the disk housed in the cartridge loaded. Among these cartridges, the first type of cartridge is the cartridge 2 as already described for the first preferred embodiment with reference to FIG. 1.

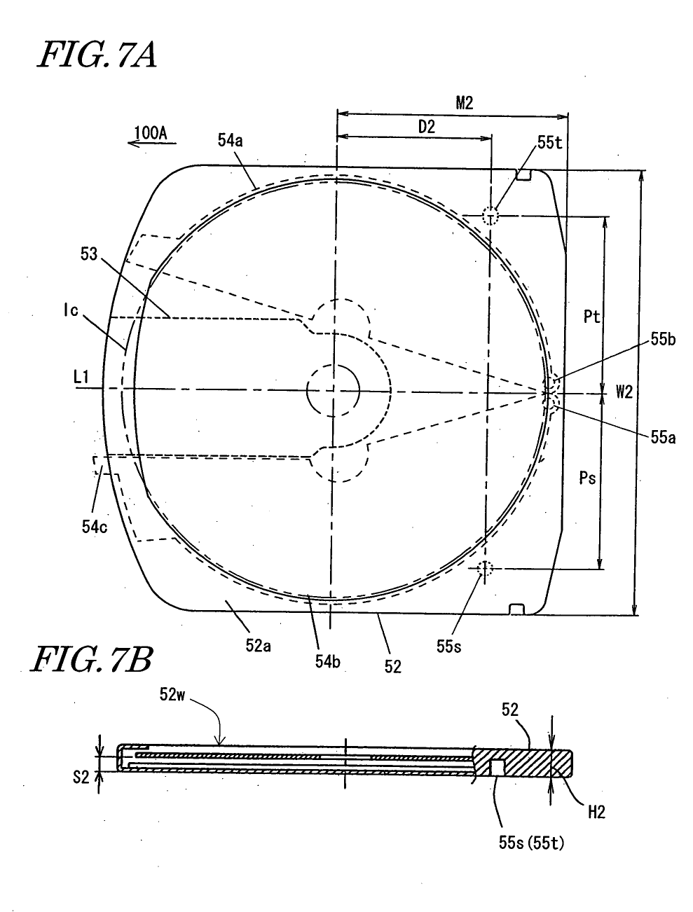

FIGS. 7A and 7B are respectively a plan view showing the upside of the second type of cartridge 52 and a cross-sectional view thereof. This type of cartridge 52 is disclosed in the pamphlet of PCT International Application Publication No. 02/056313, for example.

The second type of cartridge 52 includes a body 52a to house a disk 1c therein and has a head access window 53 to expose a portion of the data storage side of the disk 1c. The diameter of the disk 1c is equal to that of the disk 1b to be housed in the first type of cartridge 2. Two shutters 54a and 54b are provided so as to expose and cover the head access window 53 by rotating on shafts 55a and 55b, respectively. The shutter 54b is provided with a shutter opening/closing lever 54c. These shutters 54a and 54b are operated synchronously with each other by an interlocking mechanism (not shown) provided in the vicinity of the shafts 55a and 55b. Accordingly, by turning the shutter opening/closing lever 54c externally, both of these shutters 54a and 54b can be opened and closed. On the upside, the body 52a also has a disk window 52w to expose the label side of the disk 1a.

The body 52a further has positioning holes 55s and 55t to fix this second type of cartridge 52 in a predetermined position within the disk drive. Specifically, the positioning hole 55s has a circular cross section and defines the position of the cartridge 52. On the other hand, the other positioning hole 55t is elongated toward the positioning hole 55s and regulates the rotation of the second type of cartridge 52.

When the cartridge 52 is positioned within the disk drive with the disk 1c mounted on the turntable, the distance between the centerline L1 of the disk 1c, which crosses the line that connects together the respective centers of the positioning holes 55s and 55t at right angles, and the center of the positioning hole 55s is identified by Ps. On the other hand, the distance between the centerline L1 and the center of the positioning hole 55t is identified by Pt. That is to say, the distances from the centerline L1 to the respective centers of the positioning holes 55s and 55t are the same as those of the first type of cartridge 2. The distance from the center of the disk 1c to the line that connects together the respective centers of the positioning holes 55s and 55t is identified by D2, which is longer than D1. Also, the distance from the center of the disk 1a to the side surface of the cartridge 52 opposed to the head access window 53 is identified by M2, which is longer than M1. The cartridge 52 is supposed to have a width W2, which is greater than W1.

As shown in FIG. 1B, the cartridge 52 is supposed to have a thickness H2. Also, in a situation where the disk 1c is mounted on the turntable so as to rotate within the cartridge body 52a, the distance from the bottom of the cartridge 52 to the data storage side of the disk 1c is identified by S2, which is longer than S1.

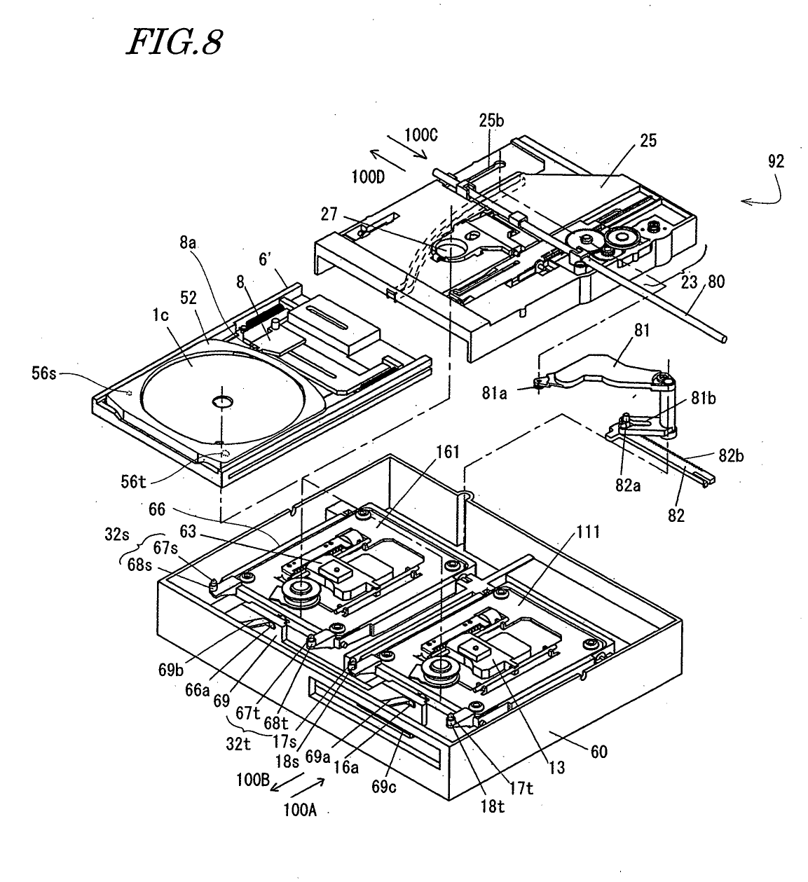

Hereinafter, a disk drive according to this second preferred embodiment will be described with reference to FIG. 8, which is an exploded perspective view of a disk drive 92 according to the second preferred embodiment. The disk drive 92 can accommodate not only both the first type of cartridge 2 and the second type of cartridge 52 alike but also a bare disk housed in the first type of these cartridge 2.

To accommodate disks complying with two different sets of standards and cartridges including those disks, the disk drive 92 has a two-head, two-traverse structure including two dedicated optical heads and two traverse bases supporting the two optical heads, respectively. Compared with a single compatible head that can accommodate two different sets of standards, this two-head structure needs a much less complicated optical system and allows the user to control the optical path much more easily. In addition, this type of structure can be downsized and developed in a shorter period of time. Furthermore, the cost of development can be cut down, too, by using existent heads.

The disk drive 92 includes a first traverse unit 111 for the first type of cartridge 2 and the disk 1b and a second traverse unit 161 for the second type of cartridge 52 and the disk 1c.

The first traverse unit 111 includes the traverse base 11, traverse holder 16, disk motor 12, optical head 13, positioning pins 31s, 31t and other members provided within the chassis 10 as already described with reference to FIG. 2. The second traverse unit 161 also has a structure similar to that of the first traverse unit 111. However, the disks 1b and 1c comply with mutually different sets of standards and require light sources with different wavelengths to read and write data from/on them. Accordingly, the second traverse unit 161 includes an optical head 63, which has a light source with a different wavelength from that of the light source of the optical head 13. Also, as mentioned above, the positioning holes of the second type of cartridge 52 are located at different positions with respect to the center of rotation of the disk than those of the first type of cartridge 2. For that reason, the second traverse unit 161 includes positioning pins 32s and 32t to fit with the positioning holes 55s and 55t of the second type of cartridge 52. As shown in FIG. 8, the first and second traverse units 111 and 161 are arranged side by side within the chassis 60.

The disk drive 92 further includes a tray 6′ and the top portion plate 25. As will be described in detail later, the tray 6′ has a structure that can mount thereon the first type of cartridge 2, the second type of cartridge 52 or a bare disk housed in any of these cartridges.

The top portion plate 25 is supported by a shaft 80 with respect to the chassis 60 so as to move in the direction pointed by the arrow 100C or 100D. A sliding arm 81, including a guide groove 81b and a pin 81a, is also secured to the chassis 60 so as to rotate freely. The pin 81a of the sliding arm 81 interlocks with the slide guide groove 25b of the top portion plate 25. The guide groove 81b engages with the pin 82a of a sliding rack 82, which is secured to the chassis 60 so as to slide freely. The sliding rack 82 has a rack portion 82b and is arranged so as to receive driving force from a sliding driving mechanism (not shown).

A lifting cam 69 is further secured to the chassis 60 so as to move in one of the directions pointed by the arrows 100C and 100D. The lifting cam 69 has cam grooves 69a and 69b and a rack portion 69c. The cam grooves 69a and 69b engage with the lifting pins 16a and 66a of the first and second traverse holders 16 and 66, respectively. The rack portion 69a receives driving force from a lifting portion by way of a decelerating gear. When the tray 6 is inserted into, or ejected out of, the disk drive or when the top portion plate 25 slides in one of the directions 100C and 100D, the lifting cam 69 moves in the direction 100C and the lifting pins 16a and 66a are located at the bottoms of the cam grooves 69a and 69b, respectively. As a result, the first and second traverse units 111 and 161 are rotated and brought down to their lowest positions so as to avoid contacting or interfering with the tray 6′ or top portion plate 25.

Hereinafter, it will be described how this disk drive 92 operates. If the first type of cartridge 2 or the second type of cartridge 52 has been put on the tray 6′, then a cartridge type recognizer (not shown) determines, by the shape of the given cartridge or a recognition hole thereof, whether the cartridge on the tray 6′ is the first type 2 or the second type 52.

If the first type of cartridge 2 has been put on the tray 6′, then the tray driving mechanism 23 inserts the tray 6′ into the chassis 60 and sets it over the first traverse unit 111. Then, the cartridge type recognizer can recognize the given cartridge as the first type 2. Since it is the first traverse unit 111 that processes the first type of cartridge 2, the top portion plate 25 does not move. In this position, the lifting mechanism drives the lifting cam 69, thereby rotating and lifting the first traverse unit 111. The operations of opening and closing the shutters 54a and 54b and clamping the disk are carried out as in the first preferred embodiment described above.

On the other hand, if the second type of cartridge 52 has been put on the tray 6′, the tray driving mechanism 23 also inserts the tray 6′ into the chassis 60 and puts it over the first traverse unit 111 first. As in the first type of cartridge 111, as the tray 6′ is going to be inserted, the opener 8 slides and the tab 8a applies an elastic force to the shutter opening/closing lever 54c of the shutter 54b, thereby opening the shutters 54a and 54b of the second type of cartridge 52. Then, the cartridge type recognizer recognizes the given cartridge as the second type 52. Accordingly, after the tray 6′ has been inserted fully, the slide driving mechanism (not shown) drives the sliding rack 82, which in turn rotates the sliding arm 81, thereby shifting the top portion plate 25 in the direction 100D. The tray 6′ is moved along with the top portion plate 25 to over the second traverse unit 161.

Once the top portion plate 25 has finished moving, the lifting mechanism (not shown) drives the lifting cam 69, thereby lifting the second traverse unit 161 upward. As the traverse holder 66 is rotated and lifted, the positioning pins 32s and 32t are also lifted, thereby getting the top portions 67s and 67t of the positioning pins 32s and 32t fitted with the positioning holes 55s and 55t of the second type of cartridge 52 by way of the clearance holes 56s and 56t of the tray 6′. In this manner, the second type of cartridge 52 is positioned horizontally with respect to the disk 1c.

Also, the base portions 68s and 68t receive the bottom of the second type of cartridge 52 around the positioning holes 55s and 55t, thereby determining the position of the cartridge 52 perpendicularly to the disk 1c. In this case, the distance between the bottom of the second type of cartridge 52 and the data storage side of the disk 1c is equal to S2 such that data is ready to be read from or written on the disk 1c. It should be noted that the disk 1c is clamped as in the first traverse unit 111.

As a result of this series of operations, the first or second type of cartridge 2 or 52 is loaded into the disk drive and one of the two traverse units associated with the disk housed in the given cartridge is selected, thereby getting the disk 1b or 1c ready to read data from or write data on. In unloading the first or second type of cartridge 2 or 52, the respective members just operate in the opposite way to that described above.

If the bare disk 1b has been inserted by itself, then the cartridge type recognizer senses that the bare disk 1b, not housed in any cartridge, has been put on the tray 6′. And the disk 1b will be mounted on the turntable of the first traverse unit 111 as already described for the first preferred embodiment. It should be noted that the disk 1c is supposed to be never inserted by itself in this preferred embodiment. Thus, every time a bare disk has been inserted by itself, that disk is always recognized as the disk 1b. Accordingly, no operation of recognizing the type of the disk inserted is carried out in this preferred embodiment. However, the disk drive may also be designed so as to receive the disk 1c by itself, too. In that case, first, the bare disk inserted may be mounted on the turntable of the first traverse unit 111. Then, the disk may be subjected to a read or write test by the optical head so as to determine whether the disk inserted is the disk 1b associated with the first traverse unit 111. If the answer is NO, then the traverse base of the first traverse unit 111 is lowered, thereby disengaging the disk from the turntable and putting it back on the tray 6′. Thereafter, the tray 6′ is moved to over the second traverse unit 161, thereby mounting the disk on the turntable of the second traverse unit 161.

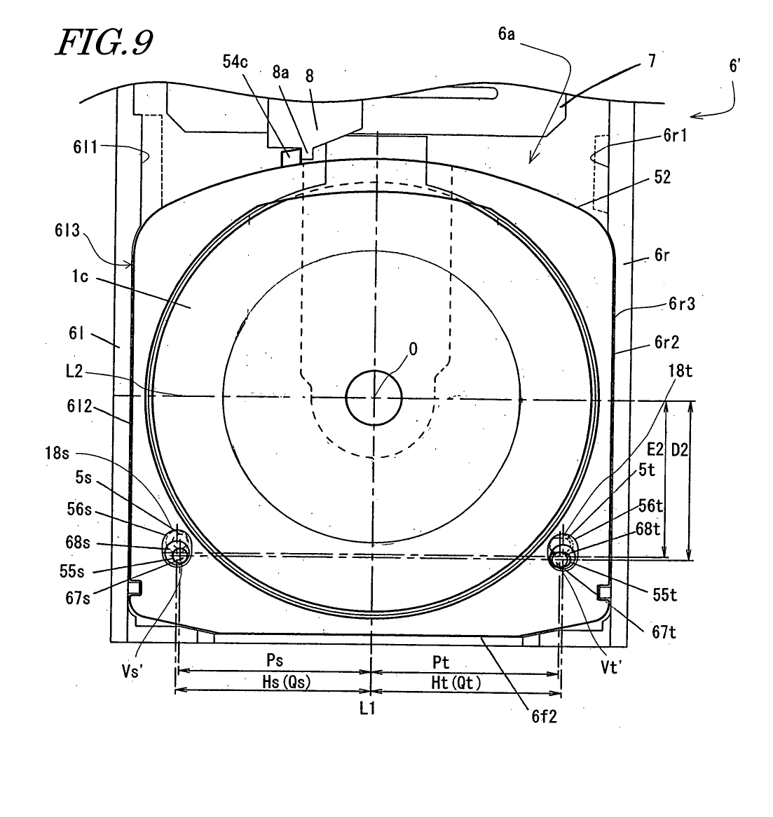

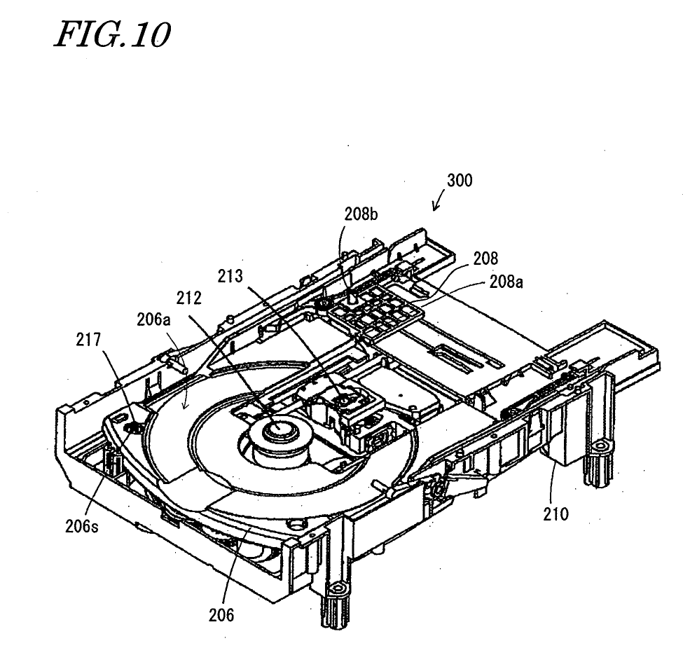

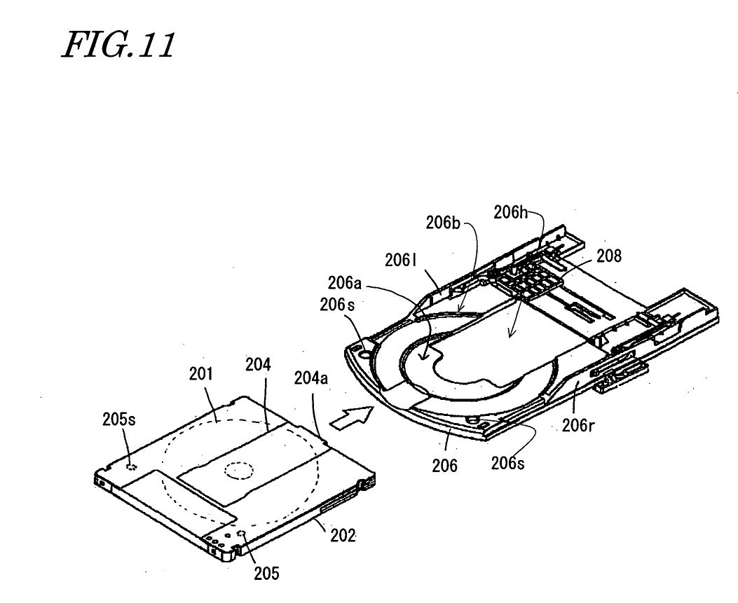

Next, the structures of the tray 6′ and positioning pins 32s and 32t will be described with reference to FIG. 9, which is a plan view illustrating a state where the second type of cartridge 52 has been put on the tray 6′. The width W2 of the second type of cartridge 52 is greater than the width W1 of the first type of cartridge 2. Accordingly, the second type of cartridge 52 is guided by portions 6l3 and 6r3 of the tray 6′, where the distance between the left- and right-hand side walls 6l and 6r is broadened, and mounted on a cartridge mount 6a so as not to contact with receiving portions 6l2 and 6r2. The second type of cartridge 52, which has been mounted on the cartridge mount 6a, receives elastic force from the springing portion 7 so as to contact with a front wall 6f2 and is fixed provisionally within the tray 6′. The tab 8a of the opener 8 engages with the shutter opening/closing lever 54c of the shutter 54b. The positioning pins 32s and 32t provided for the traverse base 66 are respectively fitted with the positioning holes 56s and 56t of the second type of cartridge 52. The circular recess 6b is also provided on the cartridge mount 6a.

When the tray 6′ mounting the second type of cartridge 52 thereon is located over the second traverse unit 161 and is now in the first position at which data is ready to be read from, or written on, the disk 1c housed in the cartridge 52, the distance from the centerline L1 to the center of the axis Vs' of the top portion 67s of the positioning pin 32s is Ps, which is equal to the distance from the centerline L1 to the positioning hole 55s of the second type of cartridge 52. On the other hand, the distance from the centerline L1 to the center of the axis Vt′ of the top portion 67t of the positioning pin 32t is Pt, which is equal to the distance from the centerline L1 to the positioning hole 55t of the second type of cartridge 52. Also, the distance from the center of the disk 1c to the line that connects together the respective centers of the positioning pins 32s and 32t is D2, which is equal to the distance from the center of the disk 1c to the positioning holes 55s and 55t of the second type of cartridge 52.

The cartridge mount 6a of the tray 6′ has clearance holes 56s and 56t to receive the positioning pins 32s and 32t such that the top portions 67s and 67t of the positioning pins 32s and 32t fit with the positioning holes 55s and 55t of the second type of cartridge 52, respectively, when the tray 6′ is located in the first position over the second traverse unit 161. These clearance holes 56s and 56t are elongated in the inserting direction. As in the first preferred embodiment described above, the distance from the centerline L1 to the center of the clearance hole 56s is Hs, while the distance from the centerline L1 to the center of the clearance hole 56t is Ht. Also, as in the first preferred embodiment described above, the distance from the centerline L1 to the center of the base portion 68s is Qs, while the distance from the centerline L1 to the center of the base portion 68t is Qt. That is to say, Qs and Qt are equal to Hs and Ht, respectively, as in the first preferred embodiment. Also, the distance from the centerline L2 to the line that connects together the respective centers of axes of the base portions 68s and 68t is E2.

These distances satisfy the inequalities Ps<Hs (=Qs) and Pt<Ht (=Qt). That is to say, the distance between the centers of axes of the base portions 68s and 68t is longer than the distance between the centers of the positioning holes 55s and 55t. The same relationship is satisfied by the positioning holes 5s and 5t of the first type of cartridge 2 and the base portions 18s and 18t.

However, as opposed to the positioning pins 31s and 31t, the distance E2 from the centerline L2 to the base portions 68s and 68t of the positioning pins 32s and 32t and the distance D2 from the centerline L2 to the top portions 67s and 67t of the positioning pins 32s and 32t satisfy the inequality E2<D2. That is to say, the centers of axes of the base portions 68s and 68t are offset so as to be closer to the centerline L2 than those of the top portions 67s and 67t are.

To load the given cartridge onto the first traverse unit 111 or the second traverse unit 161, the clearance holes 56s and 56t of the tray 6′ have their locations and shapes defined so as to receive the positioning pins 31s and 31t of the first traverse unit 111 and the positioning pins 32s and 32t of the second traverse unit 161 without interfering with their movement at all.

More specifically, the clearance holes 56s and 56t are elongated holes so as to receive both the base portions 18s and 18t of the positioning pins 31s and 31t and the base portions 68s and 68t of the positioning pins 32s and 32t. The clearance holes 56s and 56t are elongated along the line that connects together the respective centers of axes of the base portions 18s and 18t of the positioning pins 31s and 31t and the respective centers of axes of the base portions 68s and 68t of the positioning pins 32s and 32t.

As already described for the first preferred embodiment, the locations of the positioning holes of every cartridge are fixed to comply with the standards, and therefore, the top portions of the positioning pins to fit with those positioning holes may not change their locations or the centers of axes arbitrarily. However, the locations of the base portions may be changed freely as long as the base portions can support the cartridge by contacting with portions of the cartridge surrounding the positioning holes. Accordingly, in the positioning pins 31s and 31t for receiving the first type of cartridge 2, the centers of axes of the base portions are defined more distant from the center of rotation O of the disk motor than those of the top portions are, thereby bringing the clearance holes of the tray 6′ farther away from the recess 6b.

On the other hand, the positioning pins 32s and 32t for receiving the second type of cartridge 52 are located more distant from the center of rotation O of the disk motor than the positioning pins 31s and 31t for receiving the first type of cartridge 2. Thus, there is no need to consider possible interference between the recess 6b of the tray 6′ and the positioning pins 32s and 32t. Accordingly, by bringing the centers of axes of the base portions of the positioning pins 32s and 32t closer to the center of rotation O of the disk motor than those of the top portions thereof are, it is possible to prevent the clearance holes 56s and 56t, which need to receive both pairs of positioning pins 31s, 31t and 32s, 32t, from being expanded to the front side excessively. As a result, the clearance holes can be formed in their minimum required sizes. That is to say, by offsetting the base portions of the two pairs of positioning pins 31s, 31t and 32s, 32t in mutually different directions with respect to the top portions thereof, the portions between the recess 6b and the clearance holes 56s, 56t can be thickened, the mechanical strength of the tray can be increased, and the moldability can be improved as in the first preferred embodiment described above. In addition, the size of the clearance holes can be reduced, too.

Also, each pair of positioning pins 31s, 31t or 32s, 32t positions the cartridge not only within the plane parallel to the disk by using the top portions but also perpendicularly to the disk by using the base portions. Thus, the tray 6′ needs no complicated structure for positioning the cartridge vertically, and therefore, can have a simplified structure.

In the preferred embodiment described above, the distance from the centerline L1 of the first type of cartridge 2 to one of the positioning holes and the distance from the centerline L1 of the second type of cartridge 52 to one of the positioning holes are equal to each other and both identified by Ps. However, the distance between the positioning holes of the first type of cartridge 2 may be different from the distance between those of the second type of cartridge 52 as measured perpendicularly to the inserting direction. For example, the distance from the centerline L1 of the second type of cartridge 52 to one of the positioning holes may be longer than the distance from the centerline L1 of the first type of cartridge 2 to one of the positioning holes.

Furthermore, the clearance holes 56s and 56t of the tray 6′ do not have to have an elongated circular cross section but may have an elliptical, rectangular, polygonal or arc cross section. Likewise, the cross-sectional shape of the base portions 68s and 68t does not have to be circular, either, as long as the base portions 68s and 68t can be inserted into the clearance holes 56s and 56t. For example, the base portions may have an elongated circular cross section, which is slightly smaller than that of the clearance holes, so as to receive the cartridge 52 more firmly.

According to various preferred embodiments of the present invention described above, the centers of clearance holes provided through a tray are offset with respect to the centers of axes of the top portions of positioning pins. Accordingly, the gap between a recess, provided for the tray to mount a bare disk thereon, and the clearance holes can be widened, thus increasing the mechanical strength and moldability of the tray. In a preferred embodiment in which each of the positioning pins includes a top portion to be inserted into the positioning hole of a cartridge and a base portion for supporting the cartridge, the base portion expands no greater than 0.5 mm toward the center of rotation of the drive mechanism. Then, a sufficiently wide gap can be provided between the recess of the tray and the clearance holes.

Also, by providing first and second pairs of positioning pins to fit with the positioning holes of the first and second types of cartridges, respectively, and a tray with clearance holes that can receive both of these pairs of positioning pins, a disk drive, which can accommodate both the first and second types of cartridges with a simplified structure, is realized.

This application is based on Japanese Patent Applications No. 2003-343700 filed on Oct. 1, 2003 and No. 2004-273317 filed on Sep. 21, 2004, the entire contents of which are hereby incorporated by reference.

While the present invention has been described with respect to preferred embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

1. A disk drive for selectively accommodating a cartridge, in which a disk with a data storage side is housed and which has at least one positioning hole on its bottom, or the disk by itself, the disk drive comprising:
a drive mechanism for mounting, rotating and driving the disk thereon;
a head for reading and/or writing data from/on the data storage side of the disk;
a tray for putting either the cartridge or the disk thereon, the tray inserting the cartridge or the disk to a first position, in which the drive mechanism is able to mount the disk thereon, and ejecting the cartridge or the disk from the first position to a second position, in which the cartridge or the disk is removable from the disk drive; and
at least one positioning pin, which has a top portion to be inserted into the positioning hole of the cartridge to position the cartridge within a plane that is defined parallel to the disk,
wherein the tray has at least one clearance hole, into which the positioning pin is inserted such that the top portion of the positioning pin is inserted into, and fitted with, the positioning hole of the cartridge in the first position, and
wherein the center of the clearance hole is offset with respect to the center of axis of the top portion of the positioning pin.

2. The disk drive of claim 1, wherein the center of the clearance hole is located more distant from the center of rotation of the drive mechanism than the center of axis of the top portion is in at least one of two directions that are parallel to, and perpendicular to, a direction in which the tray is inserted.

3. The disk drive of claim 2, wherein the magnitude of the offset is at least equal to 0.5 mm.

4. The disk drive of claim 1, wherein the positioning pin further includes a base portion, which is provided around the top portion and which contacts with a portion of the cartridge surrounding the positioning hole, thereby positioning the cartridge perpendicularly to the disk.

5. The disk drive of claim 4, wherein the center of axis of the base portion is offset with respect to that of the top portion.

6. The disk drive of claim 5, wherein the center of axis of the base portion is offset so as to be located more distant from the center of rotation of the drive mechanism than the center of axis of the top portion is.

7. The disk drive of claim 6, wherein the center of the clearance hole of the tray matches the center of axis of the base portion.

8. The disk drive of claim 1, wherein the tray has a recess to put the disk thereon.

9. The disk drive of claim 8, wherein the gap between the outer peripheries of the recess and the clearance hole is at least 1 mm.

10. The disk drive of claim 1, wherein the clearance hole has a circular cross section.

11. A disk drive for selectively accommodating one of cartridges of first and second types, in each of which a disk with a data storage side is housed and each of which has at least one positioning hole on its bottom, or only the disk that has been housed in at least one of the cartridges of the first and second types, the positioning hole of the first type of cartridge being located at a different position from that of the second type of cartridge, the disk drive comprising:
a drive mechanism for mounting, rotating and driving the disk thereon;
a head for reading and/or writing data from/on the data storage side of the disk;
a tray for putting the cartridge of the first or second type thereon, the tray inserting the first or second type of cartridge to a first position, in which the drive mechanism is able to mount the disk thereon, and ejecting the first or second type of cartridge from the first position to a second position, in which the first or second type of cartridge is removable from the disk drive; and
at least first and second positioning pins, each of which has a top portion to be inserted into the positioning hole of its associated cartridge of the first or second type to position the cartridge within a plane that is defined parallel to the disk,
wherein the tray has at least one clearance hole, into which the first or second positioning pin is inserted such that the top portion of the first or second positioning pin is inserted into the positioning hole of the first or second type of cartridge in the first position.

12. The disk drive of claim 11, wherein each of the first and second positioning pins further includes a base portion, which is provided around the top portion and which contacts with a portion of the first or second type of cartridge surrounding the positioning hole, thereby positioning the cartridge perpendicularly to the disk, and
wherein in at least one of the first and second positioning pins, the center of axis of the base portion is offset with respect to that of the top portion.

13. The disk drive of claim 12, wherein the distance between the centers of axes of the base portions of the first and second positioning pins is shorter than the distance between the centers of axes of the top portions of the first and second positioning pins.

14. The disk drive of claim 13, wherein the clearance hole of the tray is elongated in a direction in which the tray is inserted.

15. The disk drive of claim 12, wherein in each of the first and second positioning pins, the center of axis of the base portion is offset with respect to that of the top portion, and
wherein the directions of offset in the first and second positioning pins are different from each other.

16. A cartridge positioning structure for use in a disk drive that selectively accommodates a cartridge, in which a disk with a data storage side is housed and which has at least one positioning hole on its bottom, or the disk by itself, the structure comprising:
a tray for putting either the cartridge or the disk thereon, the tray inserting the cartridge or the disk to a first position, in which a drive mechanism is able to mount the disk thereon, and ejecting the cartridge or the disk from the first position to a second position, in which the cartridge or the disk is removable from the disk drive; and
at least one positioning pin, which includes: a top portion to be inserted into the positioning hole of the cartridge to position the cartridge within a plane that is defined parallel to the disk; and a base portion, which is provided around the top portion and which contacts with a portion of the cartridge surrounding the positioning hole, thereby positioning the cartridge perpendicularly to the disk,
wherein the tray has at least one clearance hole, into which the positioning pin is inserted such that the top portion of the positioning pin is inserted into, and fitted with, the positioning hole of the cartridge in the first position, and
wherein the base portion of the positioning pin expands 0.5 mm or less toward the center of rotation of the drive mechanism.

17. The positioning structure of claim 16, wherein the tray has a recess to put the disk thereon.

18. The positioning structure of claim 17, wherein the gap between the outer peripheries of the recess and the clearance hole is at least 1 mm.

19. The positioning structure of claim 16, wherein the clearance hole has a circular cross section.

20. The positioning structure of claim 19, wherein the center of axis of the base portion is offset with respect to that of the top portion.

21. The positioning structure of claim 20, wherein the center of the clearance hole is offset so as to be more distant from the center of rotation of the drive mechanism than the center of axis of the top portion is.

22. The positioning structure of claim 21, wherein the magnitude of offset is at least equal to 0.5 mm.
